(19) United States
(12) Patent Application Publication
(10) Pub. No.: US 2002/0044848 A1
(43) Pub. Date: Apr. 18, 2002

(54) Wall plug having alignment sleeve

(75) Inventors: Stuart H. Turner, Derbyshire (GB); Martin J. Pemberton, Warwicks (GB)

Correspondence Address: NIKOLAI MERSEREAU & DIETZ, P.A., 820 INTERNATIONAL CENTRE, 900 SECOND AVENUE SOUTH, MINNEAPOLIS, MN, 55402

(73) Assignee: Turner Intellectual Property Limited, Staffordshire (GB)

(21) Appl. No.: 09/911,316

(22) Filed: Jul. 23, 2001

(30) Foreign Application Priority Data
Jan. 23, 1999 (GB) GB 9901383.1

(51) Int. Cl. F16L 5/02; F16B 1/00

(52) U.S. Cl. 411/80.1

(57) ABSTRACT

A wall plug (1) comprises a body portion (2:30:30a:40) and a rotatable portion (3:31:31a:41) received therein, the rotatable portion having a passageway (13:32:32a:42) therethrough which is offset both from the axis of rotation of the rotatable portion and also from the axis of the passageway in the body portion in which the rotatable portion is received. The rotatable portion can thus be angularly adjusted to a selected position of offset between its passageway axis and the axis of the passageway in the body portion to compensate for a hole drilled to receive the wall plug being out of position. The offset lead-in offered by the passageway in the rotatable position makes screw engagement easier than with a wholly misaligned wall plug. Means (16, 17) are provided for retaining the rotatable portion in its selected adjusted position.

### FIELD OF THE INVENTION

This invention relates to a wall plug. Such plugs are commonly inserted in holes drilled in masonry and expanded by a tightened inserted screw so as to provide a secure screw fixing into the masonry. As used herein, however, a ‘wall’ also includes structures other than ones of masonry, such as plasterboard, and ‘plug’ includes ones in which, in use, part thereof locks behind the rear surface of the ‘wall’.

The occurrence of misaligned drill holes fitted with conventional wall plugs and screws is a common problem, in that, for example, inaccurate measurement of distances can result in an error in drill hole positioning. This often necessitates the redrilling of the holes some distance from the desired position for what may only be a small error in positioning.

It is an object of the present invention to provide a wall plug which can reduce or obviate this problem.

According to the invention there is provided a wall plug having a body portion, intended to be inserted, in use, into a cavity/hole at a surface, and a further portion, the body portion having therein a passageway with a longitudinal axis, the further portion having therein a passageway with a longitudinal axis, the further portion being at least partly received or receivable in said body portion and thence adjustably movable relative to the body portion to a selected position of offset between the respective axes of the passageways.

Preferably the further portion is angularly adjustably movable relative to the body portion. Desirably, in an alternative arrangement, the relative adjustable movement is slideable, and with that arrangement movement may be possible to a selected position of co-incidence between said axis.

In one preferred embodiment of the invention the further portion is a head portion with a passageway therethrough, said head portion being moveable relative to said body portion such that the longitudinal axis of said passageway moves relative to the longitudinal axis of said body portion. Preferably the head portion is rotatable within said body portion with its passageway axis offset from the body portion axis. Alternatively the head portion can be linearly slideably adjustable relative to the body portion.

In another embodiment, the further portion is an insert which is intended to be received wholly in the body portion either before or after adjustment movement, the insert having a passageway, the axis of which is offset from a rotational axis of the insert and from the body portion when received therein.

The invention will now be described, by way of example only, with reference to the accompanying drawings in which:

FIG. 1 is a top plan view of a wall plug according to one embodiment of the present invention;

FIG. 2 is a schematic, partly sectional, side view of the wall plug of FIG. 1;

FIG. 3 is an exploded perspective view of a second embodiment of a wall plug of the present invention;

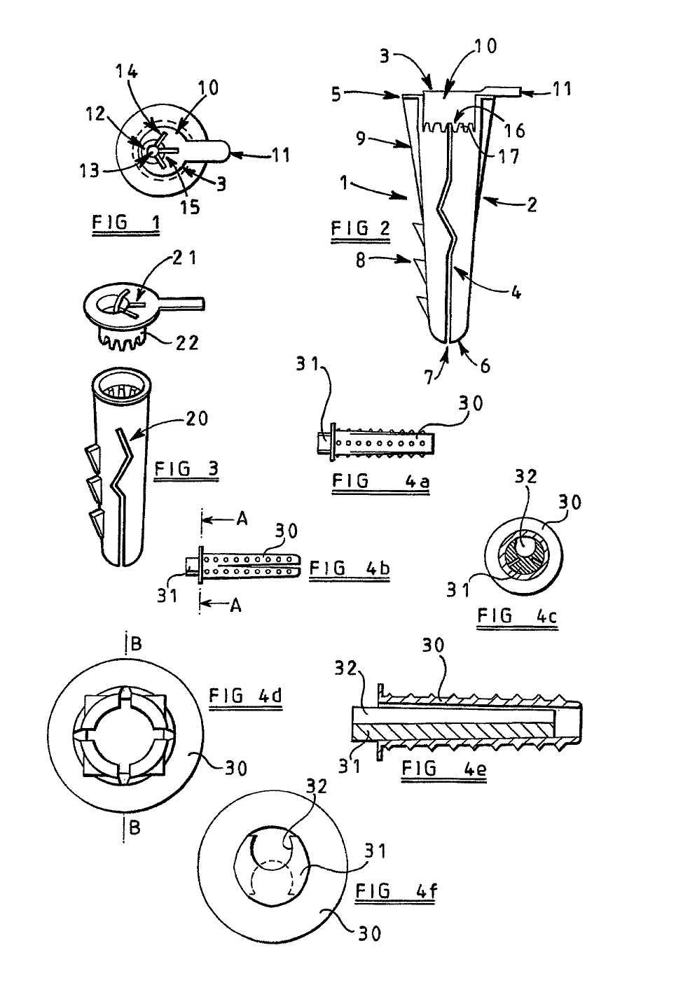

FIG. 4a is a side view of a third embodiment of a wall plug of the present invention;

FIG. 4b is a side view of the wall plug at 900 to the view shown in FIG. 4a;

FIG. 4c is an enlarged sectional view on A-A of FIG. 4b;

FIG. 4d is a view to a further enlarged scale of the lead-in end of the wall plug,

FIG. 4e is a sectional view to the scale of FIG. 4c on the line B-B of FIG. 4d;

FIG. 4f is a view to the scale of FIG. 4d of the opposite end of the wall plug from that shown in FIG. 4d, illustrating how an inserted core of the plug can be rotated;

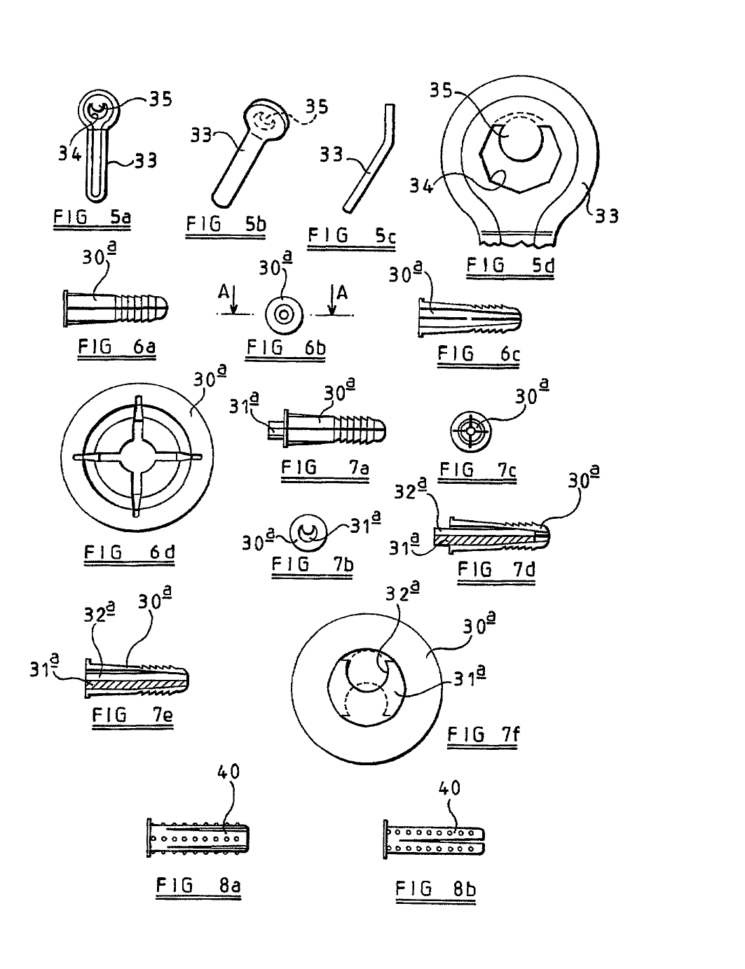

FIGS. 5a to 5c respectively are a front view, a perspective view and a side view of an adjustment tool for use with the wall plug of FIGS. 4a to 4f inclusive;

FIG. 5d is a fragmentary view to the scale of FIG. 4f showing in detail the form of an aperture defined by the tool for engaging the core insert of the third embodiment of the wall plug;

FIGS. 6a to 6d respectively are a side view of part of a fourth embodiment of a wall plug according to the present invention, a view of the trailing end of said part of the wall plug, a section on the line A-A of FIG. 6b and an enlarged view of the lead-in end of the part;

FIGS. 7a and 7b respectively are equivalent to FIGS. 6a and 6b, but show the complete wall plug where a core insert is initially partly received in the aforementioned part of said wall plug;

FIGS. 7c to 7f respectively are a view of the lead-in end of the wall plug, a sectional side view with the core shown pre-assembled ready for adjustment, the same sectional side view with the core shown fully engaged, and an enlarged view of FIG. 7b, to illustrate that the core can be rotated to any position prior to it being pressed into position into the part of the wall plug shown in FIGS. 6a to 6d inclusive;

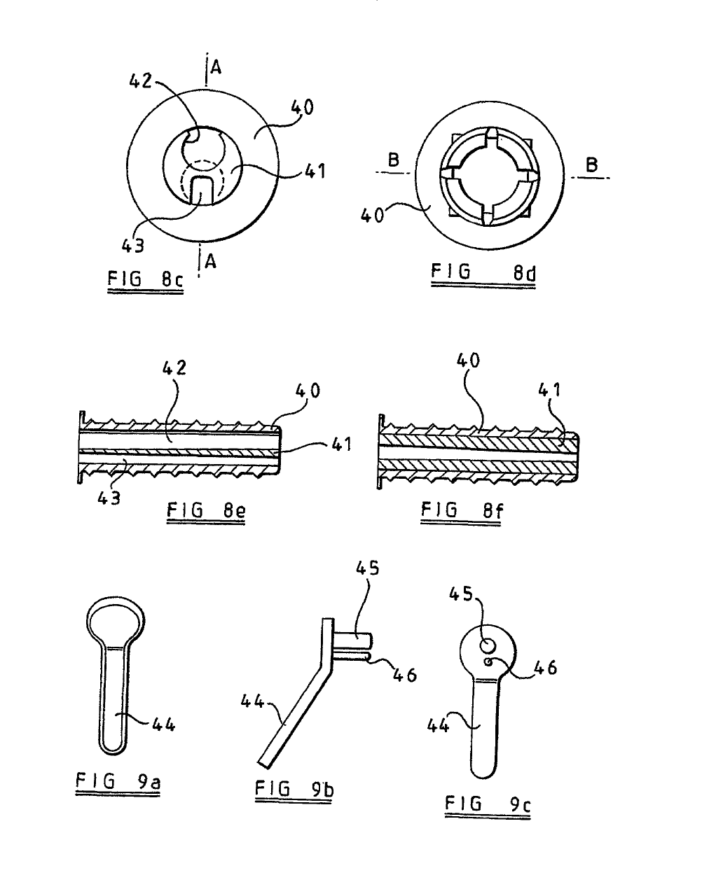

FIGS. 8a to 8f inclusive are respectively a side view, a side view at 900 to FIG. 8a, an enlarged trailing end view, an enlarged lead-in end view, an enlarged section on the line A-A and an enlarged section on the line B-B of part of a wall plug, or the whole of the wall plug as appropriate, of a fifth embodiment of a wall plug of the present invention, FIG. 8f showing a core insert of the wall plug pre-assembled ready for adjustment in said part of said wall plug; and

FIGS. 9a to 9c respectively show a perspective view, a side view and a rear view of an adjustment tool for use with the wall plug of said fifth embodiment of the invention.

A wall plug 1 includes a body portion 2 and a separate head portion 3. The body portion 2 comprises a hollow cylindrical wider end part 4 and a hollow tapered main section 4a, defining a central passageway with a longitudinal axis. At its wider end, the part 4 has, projecting radially from its outer surface, a continuous flange or ledge 5. The main section 4a terminates at the narrower end of the body portion in an arcuate surface 6. The main section 4a has at least one channel 7, and preferably two opposed such channels, passing therethrough extending from the arcuate surface 6 over part of its length, thereby to form the body portion, in the normal manner, as an expansible sleeve.

A series of triangular rib-like projections 8 are arranged longitudinally along the outside of the main section 4a. Narrow wings 9, each tapering from the outer edge of the ledge 5 to the outer surface of the main section 4a, are provided at discrete locations about the body portion 2.

The head portion 3 comprises a cylindrical shank 10 with a (hinged) tab 11 projecting radially outward from said shank 10 at one end thereof, and extending past the outer edge of the ledge 5 when fitted to the body portion 2, as will be described.

The shank 10 has a circular, or as in the illustrated embodiment, frusto-conical, depressed opening 12 at a position offset from the central longitudinal axis of said shank 10. A correspondingly eccentric passageway 13 extends longitudinally through the shank 10 from the base of the depression 12, the depression and passageway having a common longitudinal axis. Channels 14 extend radially through the wall of the frusto-conical depression 12 and the shank 10 so as to form wings 15 between adjacent channels 14. The wings 15 are resiliently deformable under an applied force.

The shank 10 has castellations 16 at the opposite end thereof from that at which the tab 11 is disposed. The castellations 16 are engageable with complementary crenellations 17 in the body portion 2 in order, in use, to prevent unintentional relative rotation between the body portion 2 and the head portion 3.

In use, upon insertion into a suitably sized hole/cavity (not shown) the body portion 2 is held in position by the triangular projections 8 and the wings 9 engaging the cavity wall.

The head portion 3 is then placed within the body portion 2 such that, in use, the castellations 16 do not engage the crenellations 17 and the head portion 3 can be freely rotated relative to said body portion 2. This relative rotation allows the passageway 13 to be positioned so as, in use, to receive the tip of a threaded shank of a screw, bolt or other fixing element (not shown), the longitudinal axis of which does not correspond to the longitudinal axis of said body portion 2, such as when the screw passes through a fixed position hole in an article to be secured to a wall surface, for example a hole in either of two spaced end brackets of a towel rail, shelf or similar.

The castellations 16 and the crenellations 17 are then engaged to prevent further relative rotation of the head portion 3 and the body portion 2. The tab 11 can be snapped/broken off to further prevent accidental rotation.

Accordingly the misalignment of the respective axes of the fixed position hole and the bore through the main body 2 is compensated for by the off-setting of the lead-in depression 12 and passageway 13 from the central rotational axis of the head portion 3, and thus also from the longitudinal axis of the passageway in portion 2. Upon insertion of the screw into the head portion 3, the wings 15 are deflected and in conjunction with the frusto-conical depression 12 serve to guide the screw threaded shank into the body portion 2. Although it enters the body portion 2 at an angle cutting more into one side thereof than the other, its initial guiding by the head portion makes screw engagement with the wall plug at least somewhat easier than with a wholly misaligned plug.

FIG. 3 shows a second embodiment of a wall plug of the present invention, which is similar to, but differs somewhat from the first embodiment shown in FIGS. 1 and 2. As shown in FIG. 3, the wall plug includes a body portion 20 and a separate head portion 21. As compared to the first embodiment, it can be seen that the head portion shank extends from one side of an enlarged diameter base, which diameter is greater than the largest diameter of the body portion 20, which itself, no longer has the extended ledge 5 shown in FIG. 2. Otherwise operation is of a very similar form to that of the first embodiment, in that a cylindrical shank part 22 of the head portion can be partly received in the top of the body portion 20 and rotated to a desired orientation in respect of the eccentric hole therein, with the castellations at the bottom of the shank being brought into engagement with the crenellations in the body portion once the correct orientation of the head portion has been achieved, so that this engagement between the body portion and the head portion then prevents further rotation of the head portion. As with the first embodiment, the wall plug would preferably be manufactured from a suitable plastics material, such as polypropylene.

The wall plug shown in FIGS. 4a to 4f is of a somewhat different form, in that although it is made up of a body portion 30 and a further separate portion, this further portion, instead of being in the form of a head, is in the form of a core insert 31 which, as shown in FIG. 4e, is in the general form of a tapered elongate rod, the taper matching the internal taper of the body portion. As shown best in FIGS. 4c, 4e and 4f, this core insert has a configurated passageway extending therethrough, this passageway 32 having its outmost part formed as an arc at the periphery of the rod and then extending slightly inwardly to part of an almost complete circle of the interior of the rod, this circle having its central axis offset, i.e. eccentric, relative to the central axis of the rod and thus to the central longitudinal axis of the body portion of the wall plug. Thus as shown in FIGS. 4c and 4f, this passageway through the core insert defines a lead-in location for a screw or other fixing element tip in the same manner as with the first and second embodiments. FIG. 4e shows the wall plug pre-assembled ready for adjustment, the core insert in this position being largely but not yet completely received into the body portion 30. The arrangement is that in the state shown in FIG. 4e, the core insert is rotated to the desired angular position of the offset passageway 32, the core insert then being pressed fully into the body portion 2 where it is thence retained as a friction fit, leaving the plug ready for insertion of the screw tip. Accordingly with this embodiment the screw is received throughout its length into the core insert and body portion, in contrast to the arrangement of the first and second embodiments where it passes through the head portion for only part of its length. Again the screw will be received at a slight angle and will cut into one side of the wall plug to a greater extent than at said other side of the threads.

FIGS. 5a to 5d shown an adjustment tool 33 for rotating the core insert 31 when it is positioned as shown in FIG. 4e. It can be seen that the tool is in the form of a one-piece cranked member, defining a handle part and a head, the head having an aperture 34 therein matching the outline profile of the core insert 31, so that in use, the head can be engaged over the projecting part of the core insert shown in FIG. 4e with a complementarily shaped projection 35 which protrudes into said aperture 34 engaging in the passageway of the core insert so as to lock the adjustment tool to said insert to allow it to be rotated to the required position relative to the body portion 30. As with the first two embodiments, indicia or other indicating means can be provided on the two wall plug components to show when the correct desired position of adjustment is reached. Once the correct position is reached, the core insert is pressed fully into the body portion 30 for further use of the wall plug as described.

The fourth embodiment of a wall plug of the present invention shown in FIGS. 6 and 7, is similar to the third embodiment in that it comprises a body portion and a core insert which is received partly in the body portion, adjustably rotated and then pressed fully into the body portion, this core insert having an offset passageway therethrough in the same manner as for the third embodiment. Accordingly this embodiment will not be described further, with the various parts of the wall plug being numbered in the same manner as for the corresponding parts of the plug of the third embodiment but with the suffix ‘a’. FIG. 7f shows how the insert core can be rotated, using an equivalent adjustment tool to that shown in FIGS. 5a to 5d, whilst FIG. 7e shows the core insert fully received as a friction fit in the wall plug body portion after having been adjustably rotated to its required position relative to the fixed screw tip position in relation to the article to be secured to the wall or other surface in which the wall plug is received.

Finally the fifth embodiment of the wall plug shown in FIGS. 8a to 8f is similar to the third embodiment described above, but differs in that the core insert has a second passageway extending through the length thereof, with the first passageway being of somewhat different form to that with the third and fourth embodiments.

Accordingly whilst the body portion 40 is of similar or identical form to the body portion 30, the core insert 41 has a first passageway 42, equivalent to the previously described passageways 32 and 32a, and also a second passageway 43 substantially diametrically opposed to the passageway 42 as best shown in FIG. 8c. It can be seen that the passageway 42 is in the form of an almost complete circle, which is without the upper arc part described in relation to the passageway 32 in FIG. 4f. Accordingly the almost complete circle extends directly to the internal circular surface of the body portion when the core insert is received in this body portion, for example as shown in FIG. 8c. The axis of the almost complete circle is again offset as compared to the central axis of the body portion and also the central axis of the core insert. The second passage 43, has its centre on a diameter which also includes the offset axis of the passageway 42, the passageway 43 being generally rectangular, possibly with slightly tapering opposite longer sides, these sides extending to the periphery of the core insert where the passageway opens in the same way as with the first passageway 42 which, as described, similarly opens at the periphery of the core insert. It is intended that the first passageway again receives the shank of the threaded screw inserted, in use into the wall plug, with the passageway 43 having its prime function to assist selected required rotational adjustment of the core insert in the body portion.

To this end there is shown in FIGS. 9a to 9c an adjustment tool of a similar form to the adjustment tool shown in FIGS. 5a to 5c, but which is specifically adapted for use with the core insert 41. It will thus be seen that instead of the configurated aperture in the head of the adjustment tool 33, the head of the adjustment tool 44 of FIGS. 9a to 9c is solid, but with two projecting pins from its rear face. One of these pins 45 has an external profile complementary with the internal shape of the passageway 42, whilst the other pin 46 has an external shape complementary with the internal shape of the second passageway 43. Accordingly it will be appreciated that the adjustment tool can be brought up to the end of the core insert and the pins 45 and 46 inserted respectively into the passageways 42 and 43 so as to ‘lock’ the adjustment tool to said core insert, so that angular movement of the tool correspondingly moves the core insert in the body portion 40 so as angularly to adjust the position of the passageway 42 into which the screw or other fixing element tip is to be received. In contrast to the third and fourth embodiment, the arrangement with this fifth embodiment is that the core insert is received fully in the body portion, as shown in FIGS. 8e and 8f before being adjusted. It might however in an alternative arrangement, be possible to adjust the core insert before it is pressed fully into the body portion, the core insert then being pressed into the body portion once it is in its adjusted position. Although retained as a friction fit in the body portion, the fully inserted insert can nevertheless be rotated by virtue of the locking engagement of the tool to the insert, in use.

Although all the wall plugs described are preferably of a suitable plastics material, such, as mentioned, as polypropylene, it is envisaged that the adjustment tools may be manufactured from glass filled nylon. For convenience, the two parts of the plug could be sold connected together, i.e. with a break-off connection.

Instead of the plug being used in a hole/cavity in a masonry wall, the plugs of the invention can be used in cavities etc in other surfaces/walls, for example with plasterboard. Moreover a plug of the invention can be of the type where the insertion of the fixing element causes an end part or end parts of the expanded plug to extend to lock behind/at the inner rear surface of the ‘wall’, given that the invention is not concerned with the expansion/locking nature of the plug.

In an alternative embodiment, not illustrated, the adjustment movement of the head portion or an insert could be linear instead of rotary, and such movement could include a position where the respective longitudinal axes of the head portion/insert and the body portion are co-incident, thereby allowing use of the plug where the cavity/hole in the ‘wall’ is correctly positioned.

What is claimed is:

1. A wall plug having a body portion, intended to be inserted, in use, into a cavity/hole at a surface, and a further portion, the body portion having therein a passageway with a longitudinal axis, the further portion having therein a passageway with a longitudinal axis, the further portion being at least partly received or receivable in said body portion and thence adjustably movable relative to the body portion to a selected position of offset between the respective axes of the passageways.

2. A wall plug as claimed in claim 1, wherein the further portion is angularly adjustably movable relative to the body portion.

3. A wall plug as claimed in claim 2, wherein the further portion is a head portion having a cylindrical or generally cylindrical shank, said shank and the body portion having respective interengaging means for preventing said relative adjustable movement when the head portion is in its selected position.

4. A wall plug as claimed in claim 3, wherein said interengaging means are an annulus of alternating recesses and projections on the body portion and a complementary annulus on the leading end of the shank inserted into the body portion, in use.

5. A wall plug as claimed in claim 3, wherein the longitudinal axis of the passageway of the head portion is offset from the rotational axis of the head portion.

6. A wall plug as claimed in claim 5, wherein the end of the shank which is outermost of the body portion in which it is received, in use, has a lead-in part at an end of the passageway of the shank, which passageway extends through the shank.

7. A wall plug as claimed in claim 6, wherein the lead-in part comprises an opening with at least one deformable wing at a side thereof to receive therethrough, in use, a shank of a fixing element.

8. A wall plug as claimed in any one of claims 3, wherein the head portion has a tab extending therefrom for use in effecting said adjustment movement.

9. A wall plug as claimed in claim 8, wherein the tab extends from the shank and a wider end of the body portion, at which the shank is received, has an outwardly radially extending annular flange.

10. A wall plug as claimed in claim 8, wherein the shank extends from one side of a flat base which, when the head portion is received in the body portion in its selected adjusted position, in use, engages the wider annular end surface of the body portion, and said tab extends from said base.

11. A wall plug as claimed in claim 2, wherein the further portion is an elongated insert.

12. A wall plug as claimed in claim 11, wherein the passageway of the insert extends inwardly from part of the outer periphery thereof and through the length of the insert, the longitudinal axis of said passageway being offset from the rotational axis of the insert.

13. A wall plug as claimed in claim 12, wherein said passageway of the insert is of non-circular cross-section.

14. A wall plug as claimed in claim 12, wherein the interior surface of the passageway through the body portion is tapered and the insert is of the same length as the body portion and has its outer surface correspondingly tapered, being fully receivable in the body portion in its selected position as a friction fit so as to be prevented from angular movement.

15. A wall plug as claimed in claim 12, in combination with an adjustment tool, the tool having a head to engage an end of the insert projecting from the body portion when the insert is only partly received therein, the head including a projection matching the cross-section of the passageway in the insert and receivable therein when the tool is engaged with said end of the insert in use, so that the tool can adjust the insert to said selected position of offset, whereafter the tool is disengaged from the insert which is pressed wholly into said body portion.

16. A wall plug as claimed in claim 12, wherein the cross-section of said passageway is part-circular, and a further passageway extends through the insert.

17. A wall plug as claimed in claim 16, wherein the further passageway extends inwardly from part of the outer periphery of the insert.

18. A wall plug as claimed in claim 16, wherein the further passageway is generally diametrically opposite said passageway of the insert.

19. A wall plug as claimed in any one of claim 16, in combination with an adjustment tool, the tool having a head from which extend projections shaped to match and be received in said passageway and said further passageway respectively, in use, when the insert is wholly received in said body portion, so that the tool can adjust the insert to said selected position of offset between the longitudinal axes of the body portion passage and said passageway of the insert respectively.

20. A method of fitting at a cavity/hole at a surface a wall plug having a body portion and a further portion with respective passageways therein having respective longitudinal axis, comprising receiving the body portion in the cavity/hole, at least partly receiving the further portion in the body portion, and adjustably moving the further portion relative to the body portion to a selected position of offset between the respective axes of the passageways.

21. A method as claimed in claim 20, wherein when the further portion is in its selected position it is moved further into the body portion to retain it in its selected position and to prevent said adjustment movement.
